(19) United States
(12) Patent Application Publication
(10) Pub. No.: US 2011/0032145 A1
(43) Pub. Date: Feb. 10, 2011

(54) Method and System for Performing Gesture-Based Directed Search

(75) Inventors: Mark D. Hansen, Buffalo Grove, IL (US); Francis P. Bourque, Mundelein, IL (US); Sanjay Gupta, Lakewood, IL (US)

Correspondence Address: MOTOROLA MOBILITY, INC, 600 NORTH US HIGHWAY 45, W2-55BB, LIBERTYVILLE, IL, 60048-5343, US

(73) Assignee: MOTOROLA, INC., Schaumburg, IL (US)

(21) Appl. No.: 12/536,662

(22) Filed: Aug. 6, 2009

(51) Int. Cl. G01S 19/51; G06F 17/30

(52) U.S. Cl. 342/357.34; 707/E17.018

(57) ABSTRACT

A method and apparatus for performing gesture-based directed search using a portable electronic device is provided. The method includes receiving geographic location information of the portable electronic device. At least one signal associated with a motion of the portable electronic device is detected and directional information is determined based on the at least one detected signal and relative to the geographic location information of the portable electronic device. Further, the method includes performing a search for at least one point of interest based on the directional information and the geographic location information of the portable electronic device and rendering the at least one point of interest at the portable electronic device.

### FIELD OF THE DISCLOSURE

The present disclosure relates generally to performing a search for a point of interest using a portable electronic device and more particularly to performing gesture-based directed search using the portable electronic device.

### BACKGROUND

Portable navigation devices usually provide the user with the ability to perform searches on “points of interest” (POIs), such as restaurants, stores, gas stations, etc. The POIs could be close to the device's location, along a route, or in a remote region selected by the user. Once a POI has been found, these devices usually provide travel directions to the POI or other relevant information such as business phone numbers, office hours, product catalog, etc. The navigation devices also allow users to specify a geographic range within which the POIs are to be searched. Conventional methods of defining a searching range include specifying a route, an address, a map, postal range etc by a user through a user interface of the device. Otherwise, a certain default search range is selected based on the device's location.

However, traditional methods of searching for points of interest mentioned previously do not always fit well with the user's experience. The usual procedure of searching for all POIs matching certain characteristics within a certain default radius of the user's location will likely return many results that are not useful to the user. Further, portable electronic devices, because of their small size, often suffer limitations in the manner in which the user navigates menus, enters data, or otherwise provides input through the user interface to specify search range. Moreover, providing such inputs using the user interface becomes a tedious task especially while the user is driving or is engaged in a dexterous activity. Further, for users who are unfamiliar with the place, defining the search range might be challenging.

Accordingly, there is a need for a method and system performing gesture-based directed search.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram illustrating a portable electronic device in accordance with some embodiments.

FIG. 2 illustrates a rendering of a gesture-based directed search on a portable electronic device in accordance with some embodiments.

FIG. 3 is a flowchart of a method for performing gesture-based directed search in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Various embodiments of the invention disclose a method for performing gesture-based directed search using a portable electronic device. The method includes receiving geographic location information of the portable electronic device. At least one signal associated with a motion of the portable electronic device is detected and directional information is determined based on the at least one detected signal and relative to the geographic location information of the portable electronic device. Further, the method includes performing a search for at least one point of interest based on the directional information and the geographic location information of the portable electronic device and rendering the at least one point of interest at the portable electronic device.

The portable electronic device for providing gesture-based search information includes a location circuit to identify geographic location information of the portable electronic device. A sensor in the portable electronic device is used for sensing a motion of the portable electronic device. The device further includes a processor, coupled to the location circuit and the sensor, for determining directional information based on the motion of the portable electronic device and relative to the geographic location information of the portable electronic device. The processor searches for at least one point of interest based on the directional information and the geographic location information of the portable electronic device and renders the at least one point of interest at the portable electronic device.

Before describing in detail the method for performing gesture-based directed search, it should be observed that the present invention resides primarily in combinations of method steps and apparatus components related to providing search information in a portable electronic device. Accordingly, the method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

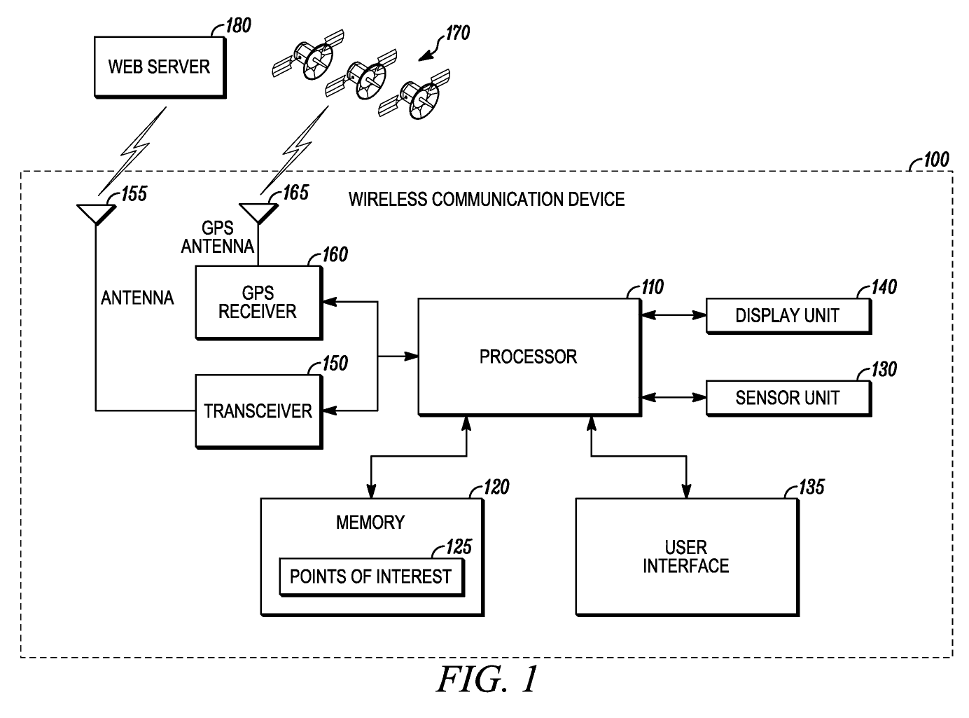

FIG. 1 is a block diagram of portable electronic device 100 in accordance with some embodiments. The portable electronic device 100 comprises a processor 110, a memory 120, a sensor unit 130, a user interface 135, a display unit 140, a transceiver 150 for communicating with a web server 180 through antenna 155, and optionally a GPS receiver 160 for communicating with the GPS satellite system 170 through a GPS antenna 165. Of course, other satellite positioning systems may be substituted for GPS such as network-based location determination. The portable electronic device 100 is an integrated unit containing at least all the elements depicted in FIG. 1, as well as any other elements necessary for the portable electronic device 100 to perform its particular electronic function(s). Alternatively, the portable electronic device 100 can comprise a collection of appropriately interconnected units or devices housed within the same physical unit, in which such units or devices perform functions that are equivalent to the functions performed by the above-described elements of the portable electronic device 100. The portable electronic device 100 may be any type of portable navigation device including, but not limited to, cellular phones, mobile stations, wireless telephones, PDAs (personal digital assistants), and hand-held GPS satellite receivers.

The processor 120 includes one or more microprocessors, microcontrollers, DSPs (digital signal processors), state machines, logic circuitry, or any other device or devices that process information based on operational or programming instructions. The processor 120 accesses a web browser which is a software application stored in memory 120 and executes the web browser application to access information such as map information through the web server 180. The web server 180 (sometimes called “application server”) is a computer that runs a program which is responsible for accepting requests from the portable electronic device 100 and for serving responses along with data content to the portable electronic device 100. The web server 180 is capable of hosting a web service. The web service used herein is a web-based application programming interface that can be accessed over a network and executed on a remote system hosting the requested service. In an example, the web service can be one of or a combination of a website, an email service, and voice over IP (VoIP) service.

The processor 120 is operationally connected to a memory 120. The memory 120 can be any form of non-volatile memory, such as a hard disk or a portable storage unit, and/or a volatile memory such as random access memory. The memory 120 includes a database 125 of user preferences and a storage space for maps of interest. The database 125 of user preferences is used for storing points of interest received via a user interface 135 from a user or retrieved based on the user's usage history/habits. Examples of POI include a, facility, establishment, enterprise, structure, person, device, tourist destination, moving vehicle, friends, members of a social community, or any other entity. Examples of user interface 135 include keypad, joystick, mouse, touchpad, microphone, speakerphone, display etc.

The transceiver 150 can be implemented as a transmitting and receiving component of the portable electronic device 100 in accordance with known techniques. In an embodiment, some of the functions of the transceiver 150 can be implemented in the processor 110. The transceiver 150 unit is used for accessing the web service wirelessly and for receiving geographic information from the web server 180. Examples of geographic information include a map, a picture, topography, etc., of a region or a route. The geographic information received from the web server includes at least latitude and longitude values of points of interest such as a place of business, a place of residence, or a facility.

In addition, the portable electronic device 100 optionally includes the GPS receiver for generating GPS position data and/or GPS velocity data using a GPS satellite system 170. The GPS satellite system 170 mentioned herein is a navigation satellite system that enables the portable electronic device 100 to determine its location, speed, direction, and time using microwave signals transmitted from GPS satellites 170. Determining a location of the device 100 refers to determining the device's 100's location with respect to a coordinate system such as latitude and longitude values. The location of the device 100 can also be determined in terms of altitude, with respect to e.g., earth's surface, using suitable sensors such as barometric pressure sensors. Foe example, the location of the device on a multi-storied building can be determined by measuring altitude with respect to earth's surface. The processor 110 can also receive geographic information such as map or route through the GPS receiver and stores the received geographic information in the memory 120. The geographic information received through the GPS receiver includes at least latitude and longitude values of locations such as a place of business, a moving vehicle, a place of residence, or a facility in a specified region or route. Antenna 155 and GPS antenna 165 include any known or developed structure for radiating and receiving electromagnetic energy in the frequency range containing the wireless carrier frequencies.

The sensor unit 130 includes one or more motion sensors for detecting motion of the portable electronic device 100. Such sensors may include accelerometers for detection of motion in any axis, digital compasses, magnetometers, and/or gyroscopes for determination of a device's bearing, and barometric pressure sensors for measuring altitude. More specifically, the motion sensors are used to generate motion parameters based on motion of the portable electronic device 100 including velocity, velocity vector, acceleration (including deceleration), tilt, displacement angle, vibration, altitude, direction, and/or any other motion parameter. Herein, the motion of the portable electronic device 100 refers to a change in the position of the portable electronic device 100, such change being caused by a gesture performed using the portable electronic device 100. Gesture is defined as a form of user input expressed or directed through a user-generated motion of the portable electronic device 100. Accordingly, a preferred geographical range or direction of search for POIs can be expressed through a gesture performed using the portable electronic device 100.

In an embodiment, the motion of the device 100 is determined with respect to an orientation of the device 100. Device orientation is defined as the device's 100's present position with respect to the earth. For example, placing the portable electronic device 100 on a table with its display side facing up has a different orientation than placing the device 100 with its display facing the table. The orientation of the device 100 with respect to the earth can be detected by using sensor device such as a 3-axis accelerometer. The 3-axis accelerometer measures acceleration in a x, y, and z axis. When the device 100 is at rest, the orientation is detected by measuring the rate of change in the acceleration across the three axes. In this case, the earth's gravity will be the only acceleration being exerted on the device with respect to the earth. The orientation of the device 100 can then be determined by sensing the acceleration due to gravity across the three sensor axes.

Other gestures may enable other types of searching experiences. A “boomerang” type of search, perhaps represented by a horizontal sweeping gesture, could search for POIs within an arc of a limited radius. A straight upward or downward thrust of the device could enable searching for POIs above or below a user, presuming the user is in a tall building or underground. In an embodiment, the search distance (e.g., radius) can be determined by measuring an intensity of a particular gesture. For example, a strong throwing motion could indicate a longer search distance than a lesser one. A measured velocity and/or acceleration of a gesture could be taken to be directly proportional to distance in term of miles/kilometers.

Thus, using the motion data from the sensor unit 130 the processor 110 recognizes a gesture performed using the portable electronic device 100. In an embodiment, the processor 110 receives location information of the device 100 through other means other than GPS positioning. Such methods include satellite-based (e.g., Glonass, Galileo), beacon-based (e.g., Loran, Wi-Fi, Cellular Cell-ID), and dead-reckoning (e.g., car based navigation system) methods.

Upon identifying a gesture and the device's 100's current location information, the processor 110 receives search parameters such as point of interest, map, route etc., from the user. Such search parameters can also be received e.g., through a user input via the user interface 135 or retrieved from memory 120. For example, the memory 120 can have a database for storing predefined user preferences and favorites. In another example, the user preferences can be listed based on tracking the user's habits/history. The processor 110 then performs a search for the specified search parameter within the geographic range defined by the gesture.

In more detail, the processor 110 performs a search based on a detected gesture and the current location information of the device 100. By providing the current location information of the device 100 to a remote server such as a location server, the processor 110 receives location information of waypoints, which are in proximity to the current location of the device 100, from the location server. The location information of waypoints can be received in terms of latitude, longitude, and altitude values. The processor 110 then selects those waypoints that lie within the geographic range defined by the gesture and customizes the search results according to user preferences stored in memory 120 or otherwise received through user input. In an embodiment, the processor performs a search pertaining to a single entity such as a person, vehicle, object, place, etc., either stationary or in motion. The processor 110 receives information, corresponding to the entity being searched, through various satellite-based and non-satellite based means. The processor 110 then customizes the search results for those entities that lie within the search range defined by the gesture and renders the results on the device 100. In another embodiment, the gesture is performed using the device 100, while the search results are rendered on a second device capable or rendering the search results. For example, the second device can be any electronic device having display properties.

In an alternate embodiment, the processor 110 provides the current location information of the device 100 and the geographic range, defined by the gesture, to the location server. The location server determines waypoints that lie within the received geographic range using the device's 100's current location as a point of reference. The location server then provides the search results to the processor 110. The waypoints can also be user-specified points of interest provided by the processor 110 to the location server. Alternatively, the processor 110 may after receiving the search results from the location server, customize the search results according to user preferences stored in the memory 120 or received directly through user input.

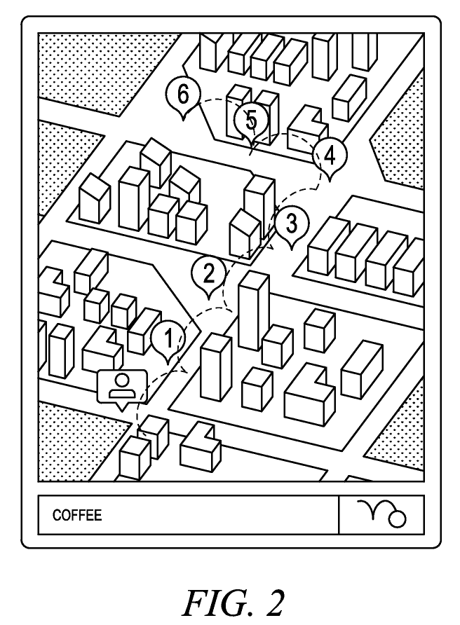

In an embodiment, the processor 110 accesses a database 125 of waypoints (POIs) from memory 120 in order to perform the search. The database 125 of waypoints is a file which can be downloaded from the location server providing such navigation services or could be a customized file uploaded by the user. The file can also include more information on a point of interest than a standard waypoint such as description information regarding the place or entity. The processor 110 then determines whether one or more of the waypoints stored in the file lie within the geographic range defined by the gesture. If one or more matches are found, the waypoints or waypoint information are rendered on the portable electronic device 100. The waypoints that fall within the search range can also be annotated on a map and displayed. For example, as shown in FIG. 2, a map of a specified search range showing points of interest can be rendered on the display of the device. The points of interest can also be rendered with information such as business hours, contact information, postal address, menu, catalog etc., on the display of the device. In an embodiment, instead of on a map, the search results can be pinpointed on a satellite imagery. In another example, the search results can be annotated by highlighting the waypoints that coincide with the user's preferences. Examples of search result(s) include but are not limited to maps, direction info, address, graphical representation, waypoints, routes, pictures, geographic coordinate values, contact information etc.

In an example, the locations of points of interest are annotated by using special effects, pointers, color effects, icons, etc. on a visual representation (e.g., map) of the search range. The map with the annotated points of interest is then displayed on the portable electronic device 100. For example, if the user preferred search parameter is a map, and the gesture is sweep action along an arc, the processor 110 would generate a map for the geographic region defined by the arc up to a default distance or a distance measured as a function of velocity. The default distance can be set by a user. In another embodiment, the processor 110 can receive search parameter prior to receiving motion data i.e., a user may input a search parameter and then make a gesture using the device 100 to define a geographic search boundary/range.

In another example, a user may want to find a coffee shop in the direction that they're traveling. A user could select “coffee shop” on a user interface 135 of the device 100 and then make a throwing motion with the device 100 in the desired direction, such as if the user were throwing a ball. Using these sensors, the processor 110 detects the throwing motion in terms of motion parameters such as acceleration, velocity, altitude, bearing, etc.; determine a present location of the portable electronic device 100 using GPS or other positioning methods; based on the detected motion parameters and the present location of the device 100, determines the direction and trajectory indicated by the user using the device 100; and then performs a search for “coffee shops” in that identified direction and within the determined search range. The processor 110 could then render the results on the display, perhaps illustrated with an animation of a bouncing ball with located coffee shops being represented by a ball bounce as shown in FIG. 2.

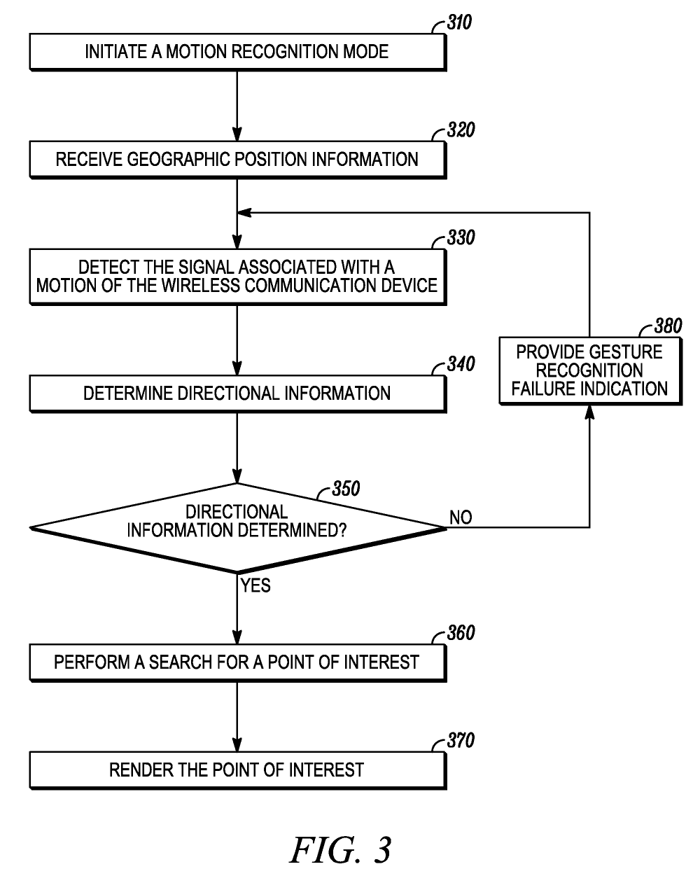

FIG. 3 shows a method for performing gesture-based directed search in a portable electronic device. At step 310 a gesture recognition mode is initiated. The mode can be activated by means of a user selection at a time of need or be set to active state by means of a default setting. In an embodiment, the gesture recognition mode can be initiated automatically upon sensing a motion of the portable electronic device. In a gesture recognition mode, a current geographic location of the portable electronic device is received 320 using any positioning means such as satellite-based, beacon-based, dead-reckoning methods, or user input. At step 330, at least one signal associated with a motion of the portable electronic device is detected using motion sensors. The at least one signal is based on e.g., velocity, acceleration, altitude, direction, rotation etc. of the device's motion. The motion sensors are further used for determining an orientation of the device. Determining an orientation of the device refers to determining a position of the portable electronic device relative to the received geographic location information and in terms of direction and trajectory.

In an alternate embodiment, the current location information of the device can be received after performing a gesture. In yet another embodiment, the current location information of the device can be received prior to initiating the gesture recognition mode. The method further includes determining 340 directional information of the device based on the current location of the device and the detected one or more motion signals. Determining directional information means determining a user-generated motion of the portable electronic device called a gesture. The directional information indicates a geographic range within which a search is to be performed. The gesture performed using the device is a form of user input to specify a user-preferred geographic search range.

At step 350, the device determines whether the gesture is recognized based on the received motion signals. If the gesture is not recognized due to various reasons including improper detection of signals, interference, etc. at the sensor unit, the device notifies 380 the user of a gesture recognition failure by providing some type of visual and/or audio alert to redo the gesture. The process again starts from step 330 and the device may then reuse the previously received geographic position information. In an embodiment, where the device is on the move, say when the user is driving, the device receives the geographic information again from a positioning means since the current location of the device would be different from previous current location. If the gesture is unrecognized due to incorrect location information, or delay in receiving a current location, the device again receives a current geographic location of the device from the positioning means and reuses the previously detected gesture.

At step 360, the device performs a search for at least one point of interest using the directional information and the geographic location information of the portable electronic device. The points of interest can be retrieved from a database in the device or received through user input. Examples of points of interest include a place, facility, establishment, enterprise, structure, person, device, tourist destination, moving vehicle, friends, members of a social community, or any other entity. In an embodiment, performing a search for at least one point of interest includes limiting the search to points of interest that lie within the determined geographic range. In an alternate embodiment, performing a search for at least one point of interest includes detecting at least one geographic location for the at least one point of interest in terms of latitude, longitude, and altitude values or postal address. For example, the location of a point of interest in multi-storied buildings can be determined by measuring altitude. The search can also include other information such as contact information, working hours, menu, catalog etc. At step 370, the device renders the search result on the portable electronic device. Rendering the at least one point of interest includes providing geographic coordinates pertaining to the points of interest in terms of latitude and longitude values and/or providing a map annotated with the points of interest.

The portable electronic device having an array of sensors may be used to enable better searching experiences. Using various types of motion sensors, the device's complete orientation in respect to the earth can be determined. Furthermore, the device's motion caused by the user called gesture, can be detected using the device. Detection of a particular gesture combined with knowledge of the device's orientation can be used to improve searching capability and provide a better experience for the user.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for providing search information in a portable electronic device, the method comprising:
receiving geographic location information of the portable electronic device;
detecting at least one signal associated with a motion of the portable electronic device;
determining directional information based on the at least one detected signal and relative to the geographic location information of the portable electronic device;
performing a search for at least one point of interest based on the directional information and the geographic location information of the portable electronic device; and
rendering the at least one point of interest at the portable electronic device.

2. The method of claim 1, further comprising determining the orientation of the portable electronic device for determining a position of the portable electronic device relative to the geographic location information.

3. The method of claim 1, wherein the at least one signal is based on at least one of velocity, acceleration, direction, and rotation.

4. The method of claim 1, further comprising determining a geographic range based on the at least one detected signal.

5. The method of claim 4, wherein performing a search for at least one point of interest comprises limiting the search to points of interest within the determined geographic range.

6. The method of claim 1, wherein performing a search for at least one point of interest comprises detecting at least one geographic location for the at least one point of interest.

7. The method of claim 1, further comprising retrieving the at least one point of interest from a database in the portable electronic device.

8. The method of claim 1, wherein the at least one point of interest is one of a place, facility, establishment, enterprise, structure, person, device, vehicle, or any entity in motion.

9. The method of claim 1, wherein rendering the at least one point of interest includes providing geographic coordinates and altitude value pertaining to the at least one point of interest.

10. The method of claim 9, wherein providing geographic coordinates comprises providing latitude and longitude values pertaining to the at least one location of the at least one point of interest.

11. The method of claim 1, wherein rendering the at least one point of interest comprises providing a map annotated with the at least one point of interest.

12. The method of claim 1 further comprising;
initiating a motion recognition mode prior to receiving the geographic location information of the portable electronic device.

13. A portable electronic device for providing search information comprising:
a location circuit to identify geographic location information of the portable electronic device;
a sensor to sense a motion of the portable electronic device; and
a processor coupled to the location circuit and the sensor, the processor being effective to:
determine directional information based on the motion of the portable electronic device and relative to the geographic location information of the portable electronic device,
perform a search for at least one point of interest based on the directional information and the geographic location information of the portable electronic device, and
render the at least one point of interest at the portable electronic device.

14. The portable electronic device of claim 13, wherein the sensor further detects an orientation of the portable electronic device for determining a position of the portable electronic device relative to the geographic location information.

15. The portable electronic device of claim 13, wherein the geographic location information of the portable electronic device includes latitude, longitude, and altitude values.

16. The portable electronic device of claim 13, wherein the sensor is at least one of an accelerometer, gyroscope, capacitive sensor, or magnetometer based sensor.

17. The portable electronic device of claim 13, further comprising a memory coupled to the processor, wherein the at least one point of interest is stored in the memory.

18. The portable electronic device of claim 13, further comprising a display coupled to the processor, wherein the at least one point of interest is rendered on the display.
